(19) United States
(12) Patent Application Publication
(10) Pub. No.: US 2007/0257378 A1
(43) Pub. Date: Nov. 8, 2007

(54) METHOD AND DEVICE FOR THE GASSING OF WATER

(76) Inventor: Pasquale Spiegel, Glinde (DE)

Correspondence Address: HENRY M FEIEREISEN, LLC, 350 FIFTH AVENUE, SUITE 4714, NEW YORK, NY, 10118, US

(21) Appl. No.: 10/597,999

(22) PCT Filed: Feb. 16, 2005
(86) PCT No.: PCT/DE05/00261

§ 371 Date: Jun. 14, 2007

(30) Foreign Application Priority Data
Feb. 16, 2004 (DE) 10 2004 007 727.4

(51) Int. Cl. B01F 3/04

(52) U.S. Cl. 261/22; 261/23.1; 261/DIG. 7

(57) ABSTRACT

A method is disclosed for increasing adsorption of gas into water which is gassed at least in a gassing chamber in the form of a gas/water mixture and after leaving the gassing chamber, is guided through at least one gassing device located downstream from the gassing chamber, in which the gas/water mixture is being thoroughly mixed. In a device of a gassing chamber (48) and at least one inline gassing device (26) for thoroughly mixing a gas/water mixture, gassed water is fed through the inline gassing device which is connected downstream to the gassing chamber (48) wherein the gas/water mixture is thoroughly mixed.

The invention relates to a method for increasing the adsorption of gas into water, in which the water is present at least in a gassing chamber where it is being gassed. In addition, the invention relates to a device for increasing the adsorption of gas in water, where the water is present at least in a gassing chamber.

Especially in the area of table water production or other carbonated drinks, various methods and devices for gassing liquids are known and in particular also the introduction of CO₂ into water. For this purpose, water and CO₂ are filled into a carbonator chamber. By means of various method steps, especially atomizing the water, conditions are provided inside the carbonator chamber which favor the mixing of CO₂ with the water.

The so resulting carbonated water or any other type of carbonated drinks is in many respects not satisfactory. On the one hand, the CO₂ gas mixes only partially with the water, and frequently when pouring the gas/water mixture into a drinking cup, the gas quickly escapes again form the gas/water mixture, such that at a slow drinking speed, a large portion of the drink no longer contains any CO₂. On the other hand, the gas is distributed within the water in large bubbles which do not provide the desired brisk sensation upon drinking. Finally, in particular, when the soft drinks drawn from a tap are supplied with flavorings, unwanted foaming can occur so that a substantial amount of the drink spills over the rim of the drinking cup; alternatively, the drawing has to be done very slowly to avoid the foaming and spilling. It is generally known that all drinks that are drawn from a tap as post-mix drinks exhibit heavy foaming upon drawing. This even increases when the tap unit has to fulfill high capacity output. In such cases, there is also frequently the possibility that the cooling system arranged either upstream or downstream of the tap also fails, in which case the temperature of the drinks increases several degrees. The increase in temperature thus considerably increases the formation of foam, such that drawing from the tap has to be stopped in order to lower the temperature again. A particular tapping method has shown to be practicable where a still water switch is built in, so that the carbonated liquids can be diluted with still water. This represents a possible manner to regain control over the foaming to a point where drinks can again be drawn from the tap.

A similar problem occurs at carbonator systems or saturating systems that due their age show wear and tear. Such older systems normally need recalibration several times a week. This causes increase in costs through expenditure of time and personnel.

The afore-stated problems are generally noticed with carbonators such as non-refrigerated carbonators, shock carbonators and also recirculation carbonators. Problems appear and oftentimes appear regardless of the age of the unit. Manufacturers of all types of systems are confronted with the same problems, namely foam formation and temperature fluctuations.

It is therefore an object of the present invention to provide gassing systems which are substantially free from such problems as foam formation and temperature fluctuations.

This object is attained by the present invention in that in the afore-stated method the gas/water mixture which is leaving the gassing chamber is guided through an inline gassing device downstream from the gassing chamber and thoroughly mixed in the inline gassing device.

In providing the inline-gassing device, the problem of the foam formation can be completely prevented with relatively little energy and rather low input costs. The impregnated liquid from the gassing chamber is post impregnated in the inline gassing device and then guided to the location where the liquid can be tapped.

Due to this independent post-impregnation without the need for supplying gas or still water into the gas-water mixture, a very fine diffusion of the gas into the liquid which was already impregnated with CO₂ is realized such that a very fine beaded liquid is obtained at the tap. This fine diffusion of the gas is realized by guiding the liquid across a large surface which is increased manifold by the presence a granulate inside the inline-gassing device such that the gas contained in the gas/water mixture can be further adsorbed by the liquid as it is streaming through the granulate to thereby realize an increased uptake of gas, due to the liquid passing through the increased surface of the granulate. Such an arrangement results in a thoroughly fine beaded gas/water mixture, wherein the gas is extremely well adsorbed into the liquid, such that when the liquid is drawn from the tap, the gas remains adsorbed in the water. This prevents the foam formation when tapping post-mix drinks, even if high sugar or sweetener content in the syrups that are utilized for drinks are otherwise favor such foam formation. Such a thorough adsorption of the gas into the liquid cannot be realized by conventional methods, where only always short-lived impregnation is possible, and the gas is released from the liquid upon tapping, in which case, heavy foam formation is seen when drawing drinks from the tap. Such foam formation is preventable with the inline gassing device, which can be operated with refrigerated or non-refrigerated liquids.

In accordance with a preferred embodiment of the invention, the gas impregnation can be carried out with recirculation carbonators or by means of shock carbonators before the liquids produced in these carbonators are subsequently further impregnated in the inline gassing device. When using recirculation carbonators the inline gassing device can be integrated into the circulation lines, or, when using shock carbonators the inline gassing device can be integrated into the supply line connected to the tap faucet.

In such retrofitted impregnation or drink dispensing systems, very good drawing results can be realized independent of current temperature fluctuations of the liquids and without loss of quality. A formation of foam is also prevented.

A further advantage of such inline gassing devices is the ability to design the entire tapping system without any unwanted side effects. Should it occur that no impregnation of the liquid is taking place in the gassing chamber, operation of the installation can be adapted on short notice such that the impregnation is taking place only in the inline gassing device. For this purpose, the inline gassing device must be connected directly to the gas supply. Such a connection is easily possible due to the type of assembly of the inline gassing device. Thus, operation of the system in conjunction with a gassing chamber can be continued if the system is fitted with an inline gassing device. This auxiliary method can already be incorporated into a newly built impregnation system with the view toward preventing the possibility of an outage of the system due to the known failures. By providing the inline gassing device with gas and liquid, preferably refrigerated liquid, operation of the impregnation installation can be maintained especially if at least one pump is provided and operable for increasing the pressure in the liquid. Such an impregnation assembly is capable to maintain high tapping speed even in the post-mix area.

The trouble-free operation of such systems results in substantial cost advantages for the operator. With regular operation of the system, tapping speed and therefore tapping of post-mix drinks can be considerably increased due to the lack in foam formation. If difficulties arise in the operation of the gassing chamber, the entire operation of the instillation can be switched to the inline gassing device, such that after only a short break, the entire installation can again be in operable condition.

Other features and advantages of the present invention will be more readily apparent upon reading the following detailed description of preferred exemplified embodiments of the invention with reference to the accompanying drawing, in which the preferred embodiments are illustrated.

The drawings show:

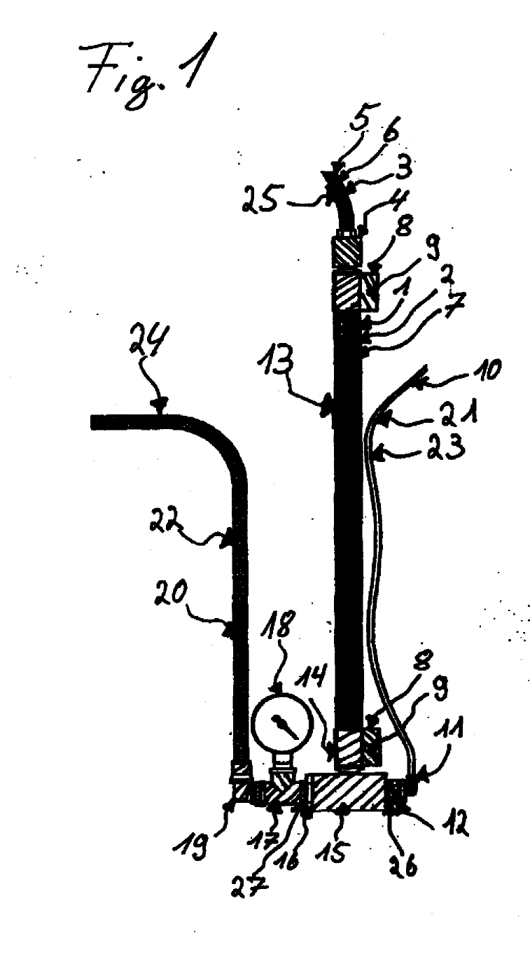

FIG. 1 a detailed view of a section of an impregnation system provided with an inline impregnation device;

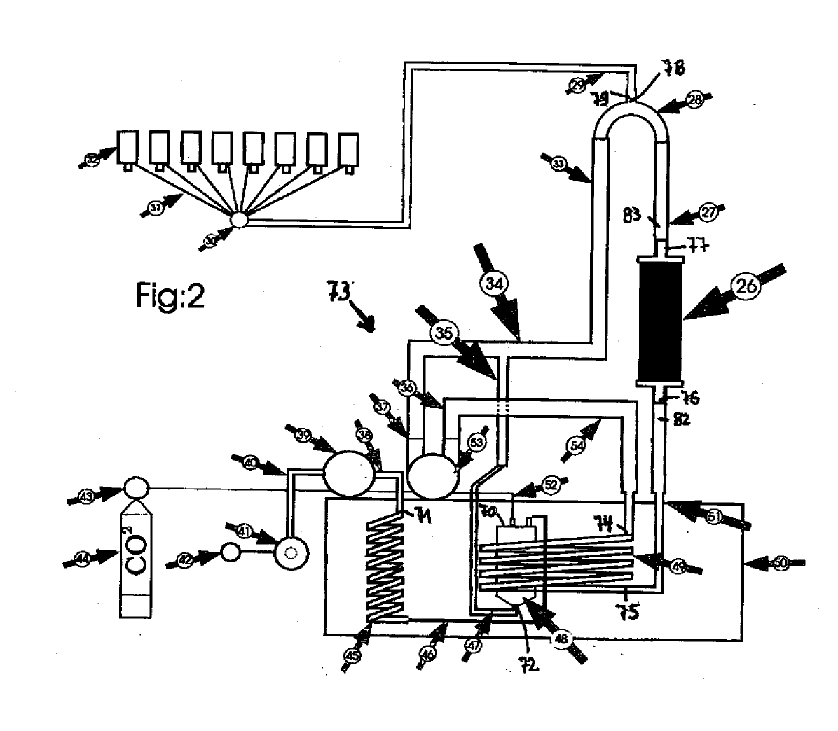

FIG. 2 a schematic illustration of a recirculation carbonator with an inline gassing device disposed outside a housing;

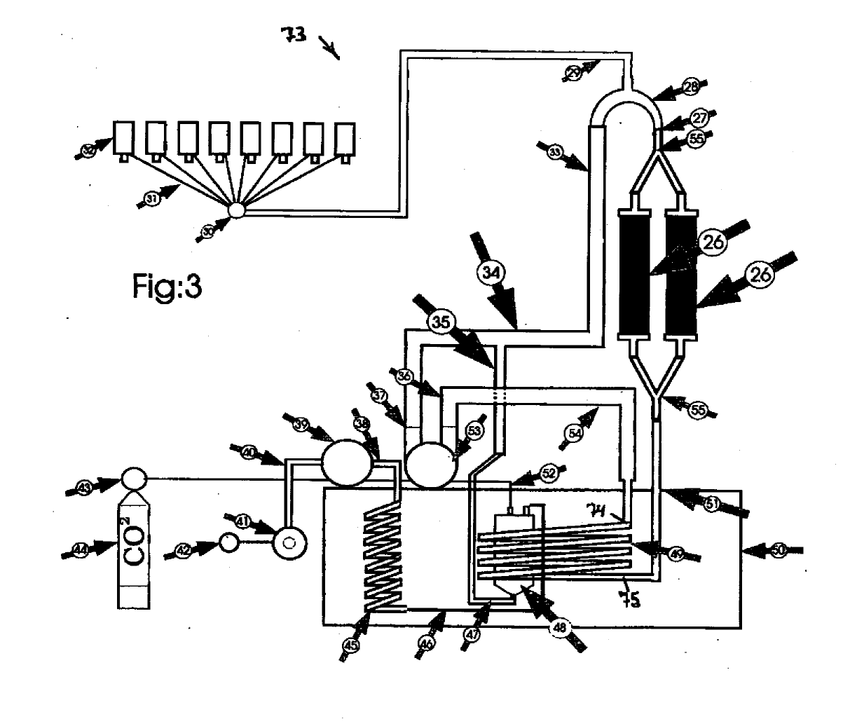

FIG. 3 a schematic illustration of a recirculation carbonator with two parallel mounted inline gassing devices outside the housing;

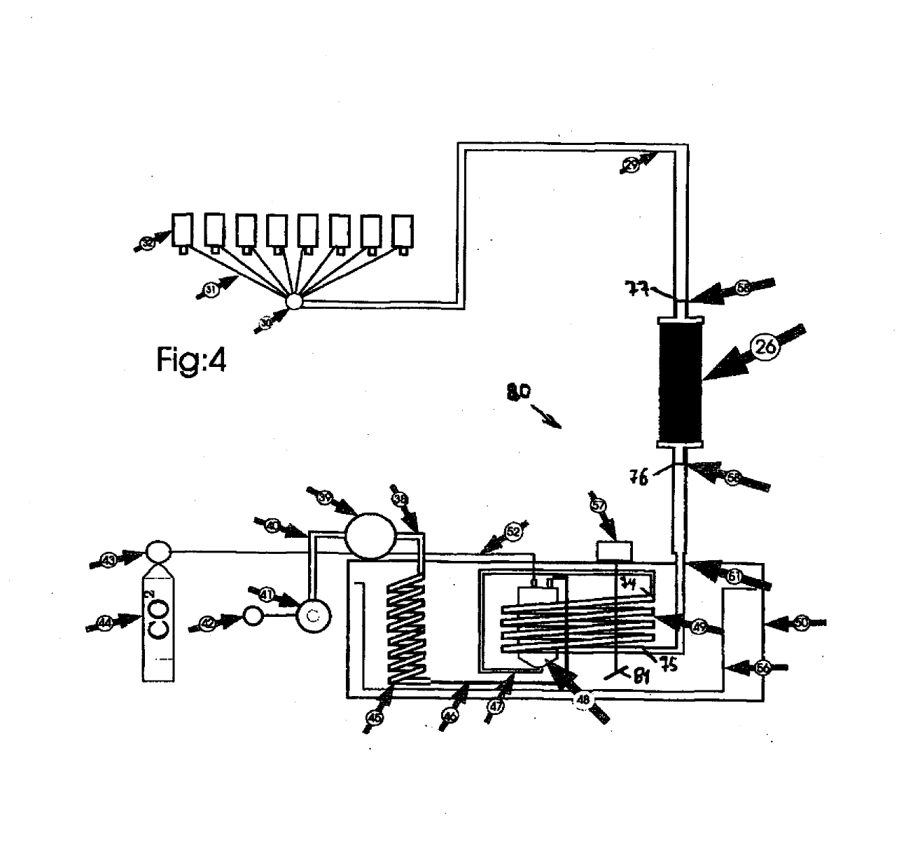

FIG. 4 a schematic illustration of a shock carbonator with an inline gassing device outside the housing;

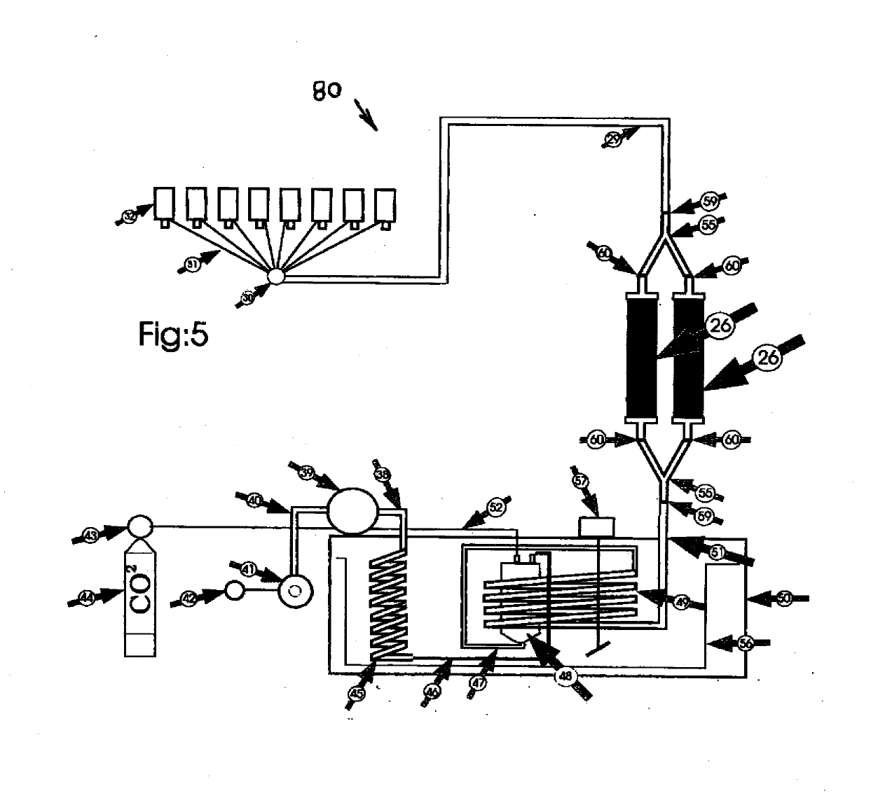

FIG. 5 a schematic illustration of a shock carbonator with to inline gassing devices mounted parallel to each other, outside the housing;

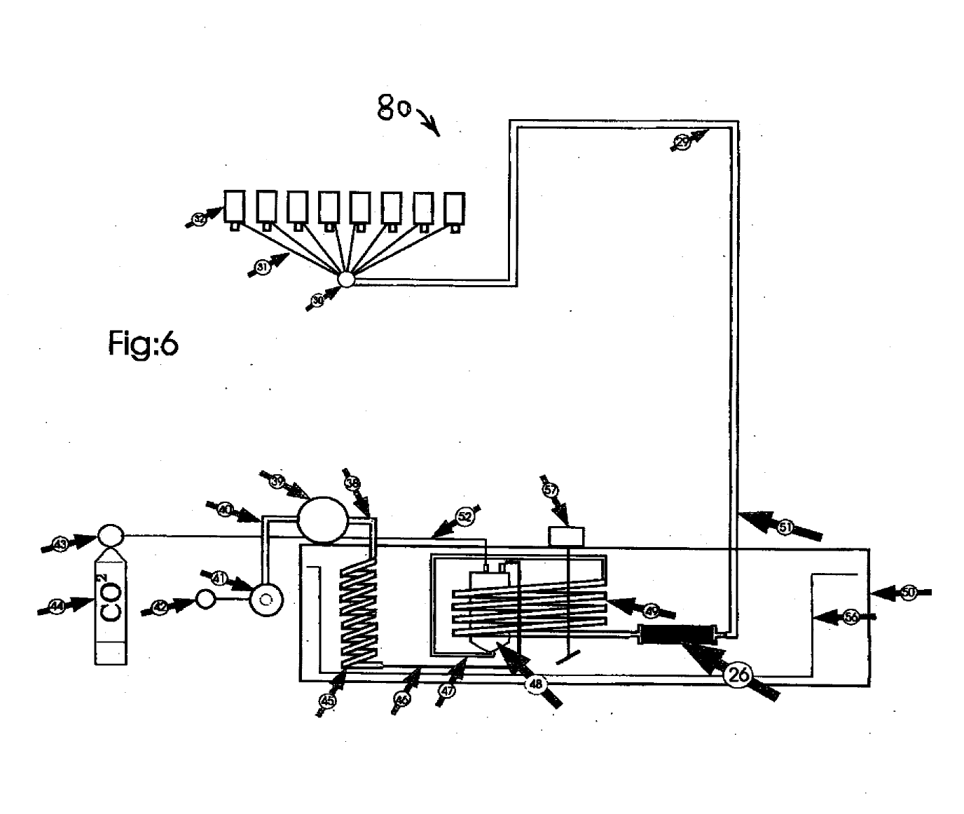

FIG. 6 a schematic illustration of a shock carbonator with an inline impregnation device disposed inside the housing;

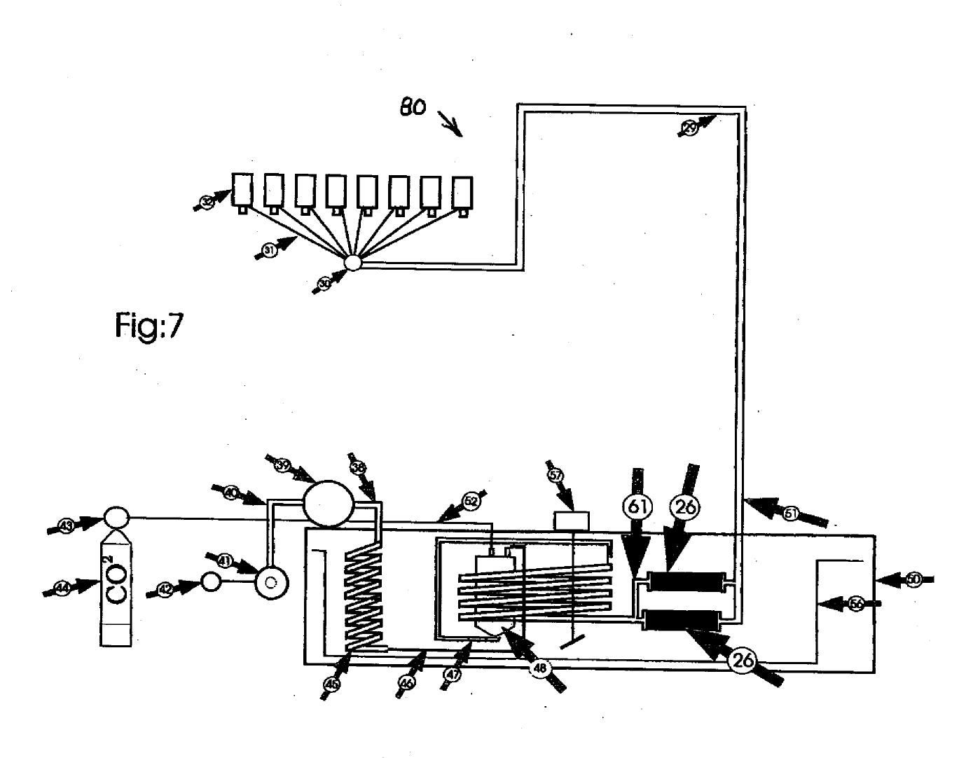

FIG. 7 a schematic illustration of a shock carbonator with two inline impregnation devices mounted parallel to each other inside the housing;

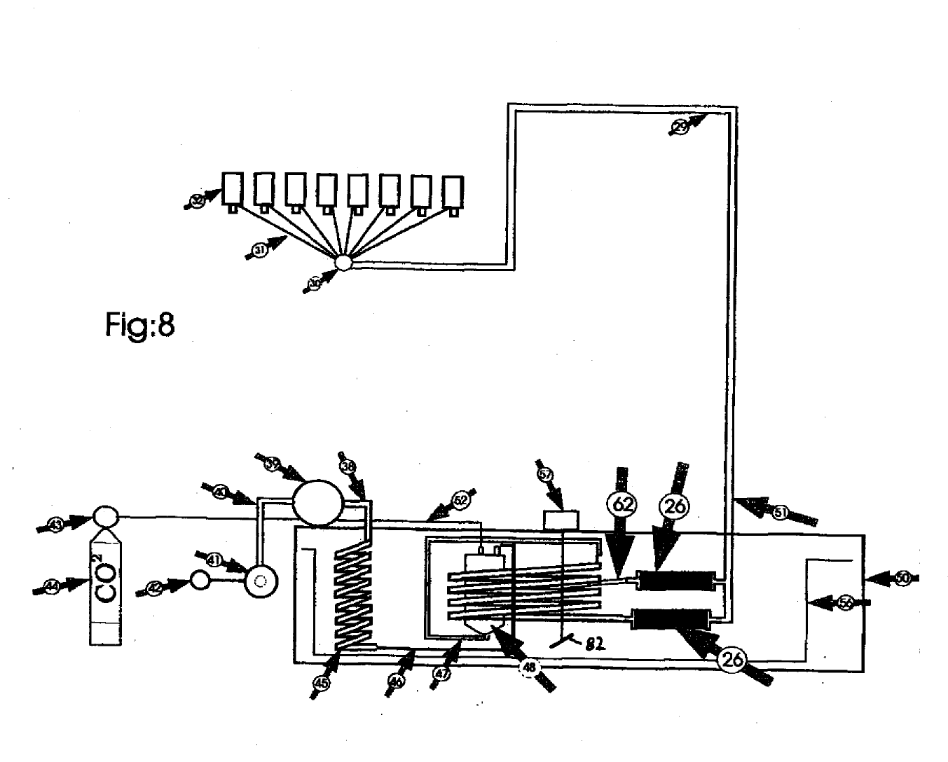

FIG. 8 a schematic illustration of a shock carbonator with two parallel mounted inline gassing devices, each of which provided with a separate connection line;

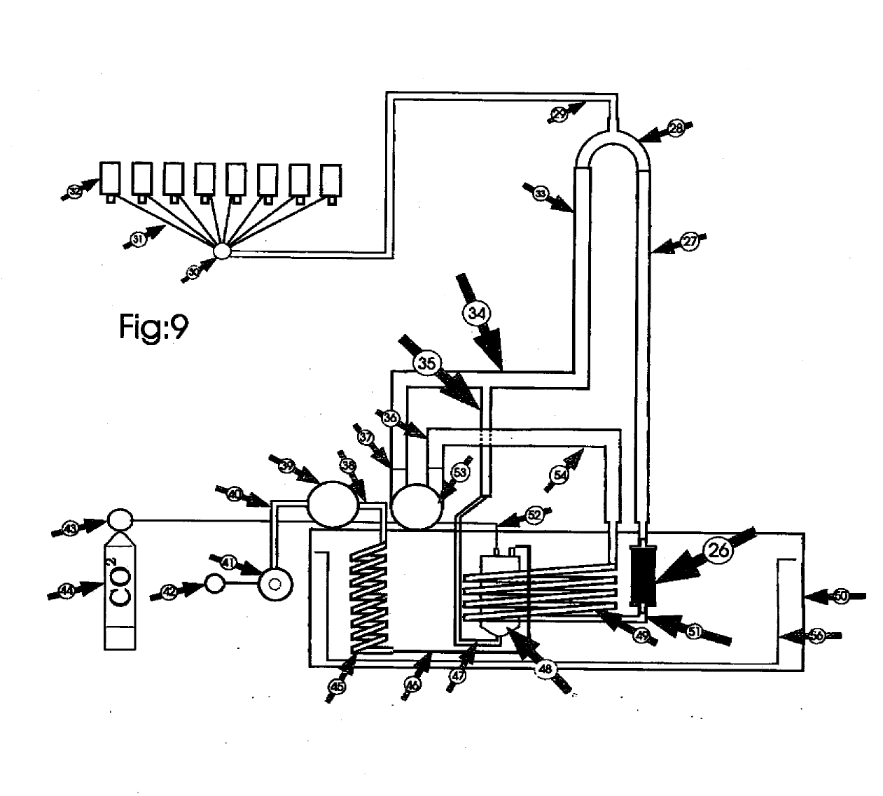

FIG. 9 a schematic illustration of a recirculation carbonator with a inline gassing device inside the housing;

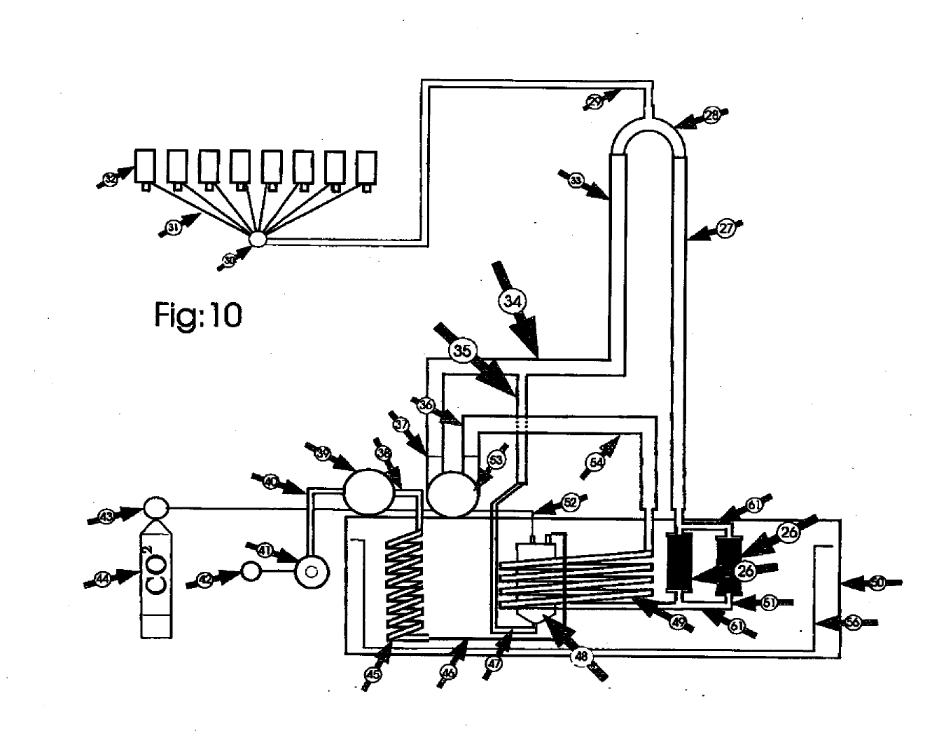

FIG. 10 a schematic illustration of a recirculation carbonator with two inline gassing devices mounted parallel to each other; and

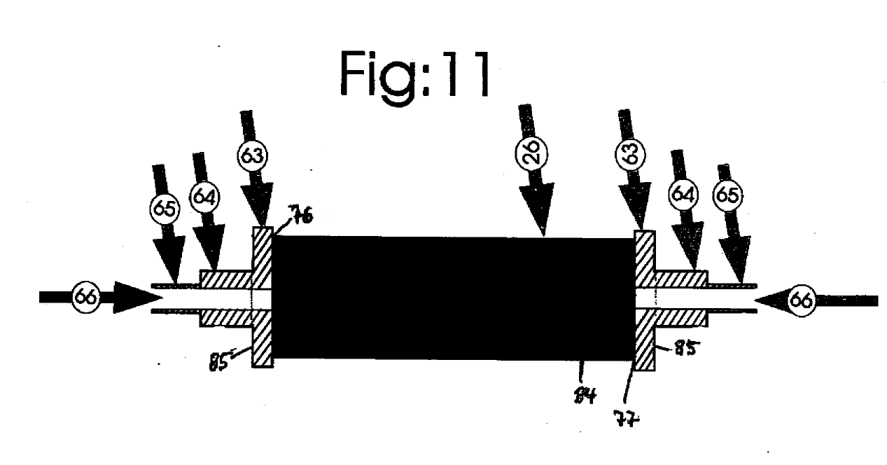

FIG. 11 a longitudinal section view through an inline gassing device.

A device for gassing liquids consists essentially of a gassing chamber, which when gassing with CO₂ is defined as a carbonator chamber (48), an inline gassing device, which when gassing with CO₂ is defined as an inline carbonator (26), and a pressure elevator pump (39), a gas supply (44), tapping points (32), a housing (50), a first cooler (45) and a second cooler (49). The first cooler (45) is connected via a connector line (46) with an upper sealing cover (70) of the carbonator chamber (48), with a passageway extending into the interior space of the carbonator chamber (48). In this interior space, a mixing of the cold water supplied via the connector line (46) into the carbonator chamber takes place with a gas, which is supplied from the gas supply (46), via a supply line (52) and the upper sealing cover (70), into the interior of the carbonator chamber (48).

The first cooler (45), at its upper end (71) facing away from the connector line (46), is connected with the input line (40) by which a liquid from the main supply line (42) is supplied into the first cooler (45) via a control (41). Disposed in the input line (40) is the pressure elevator pump (39), which provides a steady pressure in the liquid circulation following the cooler (45).

At its lower end (70), opposite the upper end with the sealing cover (70), the carbonator chamber (48) is connected to an exit line (47) through which the gas/water mixture produced in the carbonator chamber (48) is guided through in direction of the inline carbonator (26). In a recirculation carbonator (73), the exit line (47) ends into an ascending line (35) from where the gas/liquid mixture is directly fed into a circulation line (34). Located in the circulation line (34) is a displacement pump (53) connected to circulation line (34) via connectors (37) and responsible for pumping over the gas/water mixture in the circulation line. At its high pressure side, the displacement pump (53) is connected with the feeder line (36) which is connected to an upper end (74) of the second cooler (49) via a cooling line (54). Through this upper end, the gas/liquid mixture is entering the second cooler (49) and leaving through the lower end thereof (75) via an exit line (51) in the direction of a lower supply line (76) of the inline carbonator (26).

In the inline carbonator (26) the gas/liquid mixture gets thoroughly mixed. After this thorough mixing, the carbonized liquid leaves the inline carbonator (26) from the upper exit line via a drawing line (27) in direction of a U-line (28) which is connected via a cycling line (33) with the circulation line (34) through which the carbonized liquid is re-guided to the displacement pump (53). At its highest point (78), the U-line (28) has a drawing location (79) through which the liquid, which has been carbonated in the inline carbonator (26) is drawn. This drawing location (79) is connected with the taps (32) via an exit line (29). The taps (32) can be utilized to draw the liquid which has been carbonated in the inline carbonator (26). In addition, these taps may also be constructed as post-mix faucets, such that when drawing the carbonated liquid, syrup can be simultaneously put into a drinking cup to be filled at the taps (32). Each of the taps (32) is connected via a tap line (31) to a distributor (3) which is adapted to supply each of the taps (32) with the carbonated liquid.

To carbonate liquids, a shock carbonator (80) can be utilized instead of a recirculation carbonator (73). Similar to the recirculation carbonator (73), the shock carbonator (80) is provided with a carbonation chamber (48) which is connected via a gas supply line (52) with a gas supply (44) and connected to the first cooler (45) via a connector line (46). The gas/liquid mixture which exits the carbonator chamber (46) is fed directly into a second cooler (49) via a drawing line (47) without the gas/liquid mixture first entering into a circulation line (34). Also, in this shock carbonator (80), the first and second cooler and the carbonation chamber (48) are both located inside a housing (50). From the housing (50), the exit line (51) directly enters the inline carbonator (26). The inline carbonator includes two connection points (58), of which one is connected with the exit line (51) and the other with the exit line (29), which are both joined into the distributor (30) of taps (32).

Similar to the recirculation carbonator (73) the liquid supply is controlled via a main supply connector (42) and a control unit (41). A pressure increase pump (39) keeps the liquid pressure steady before the liquid enters the first cooler.

Likewise, in the shock carbonator (80) a gas supply (44) controlled by a gas pressure control (43) supplies the carbonator chamber (48) with a constant gas pressure via the gas supply line (52).

Both with the recirculation carbonator (73) and the shock carbonator (80), a basin (56) can be provided in the interior of the housing (50) for receiving a water bed (not shown here). Arranged within this water bed are the first and the second cooler (45, 49) and the carbonator chamber (48). The waterbed ensures a constant cooling temperature within the basin (56). For this purpose, a mixer (81) is provided inside the basin (56) and driven by an agitator motor (57). The mixer (81) effects a water circulation inside the basin (56) and adjusting essentially to a steady temperature within the entire basin.

Both, with the recirculation carbonator (73) and the shock carbonator (80), several inline carbonators (26) mounted parallel to each other can be used instead of just one inline carbonator (26) (FIG. 3 and 5). Each of the two parallel mounted inline carbonators (26) is connected separately with the exit line (51) and the second cooler (49) as well as with the drawing line (27) at the recirculation carbonator (73), respectively, the exit line (29) at the shock carbonator (80). Correspondingly, the branches (55) are connected via connectors (59) with the neighboring lines (51) respectively, (29). Each arm of each branch (55) connected with the inline carbonator (26) via a connector (60).

In FIGS. 2, 3, 4, 5 the inline carbonators (26) are connected with the neighboring lines (51, 28, 29) outside the housing (50). This arrangement has proven successful, when carbonating systems, which were first only provided with one carbonator chamber (48), were retrofitted with one or more inline carbonators (26) in order to improve the quality of the so produced beverage, for example a soft drink. In comparison FIGS. 6, 7, 8, 9 and 10 show carbonator systems which were fitted at production with the inline carbonators (26) for improving the quality of the beverages. With the latter systems, the inline carbonators (26) are integrated into in the pipe system disposed within the housing and this arrangement is the same for the shock carbonators of FIG. 6, 7, 8 and the recirculation carbonators of FIGS. 9 and 10. Both with the shock carbonator (80) and the recirculation carbonator (73), other construction designs are possible where one or more inline carbonators (26) are disposed within the housing (50) respectively the basin (56). In particular, when utilizing the basin (56) such a construction ensures that the temperature of the gas/liquid mixture which passes within the inline carbonators (26) is maintained at the level of the temperature of the water bed inside the basin (56).

When utilizing several inline carbonators (26), advantageously, they should be mounted parallel to each other by means of a branch to the exit line (51) which leaves the second cooler (49). In that case, the inline carbonators (26) mounted parallel to each other are connected to each other via connecting lines (61) either when the carbonated liquid is entering the gas/liquid mixture or also when exiting the inline carbonator (26).

It is also possible, to connect each of the several inline carbonators (26) via a separate cooling line (62) with the second cooler (49) (See FIG. 8).

When retrofitting the inline carbonators (26), the construction as shown in FIG. 11 is especially suitable. Accordingly, it is advantageous when retrofitting the inline carbonators (26) to utilize an exit hose line in the area of the housing (50). This hose line is cut and a portion thereof corresponding to the length of the inline carbonator (26) removed. Then the inline carbonator is connected by each of its respective ends with the corresponding end (82) of the hose line of the exit line (51) respectively with the hose end (83) of the drawing line (27) respectively the exit line (29). The hose ends (82, 83) have identical cross sections and the same inside diameter. Depending on the construction of the particular carbonator system, two different hose measurements are considered for connecting the inline carbonator (26). One of the hoses has a larger inside diameter and the other one a smaller inside diameter.

In order to realize the greatest variety of uses, the hollow body surrounding the inline carbonator (22) is advantageously constructed as a tube (84) for holding the granulate over which the gas/water is flowing. Each of the tube ends (76, 77) is closed by means of a flange (63). The flange (63) at the side facing away from the tube (84) is provided with slide-on surfaces (64, 65) that surround a common bore (66). Through this bore the gas/water mixture to be carbonated enters on the one hand, the granulate filled tube (84), and on the other hand exits in the direction of the neighboring drawing line (27) respectively, the exit line (29). Depending on the inner diameter of each of the hose ends (82, 83) which connects to the inline carbonator (26), the end at either a larger or smaller inner diameter (65) is slid over the slide-on surface (64) and is for example clamped on to the respective slide-on surface (64) at a larger or smaller inner diameter.

The direction in which the gas/water is flowing through the inline carbonator does not matter. Independent of whether the liquid to be carbonated which enters through the bore into the pipe (84) is neighboring the supply (76) or the bore is neighboring the supply line (77) of the inline carbonator (26), the same thorough mixing of the gas/liquid mixture takes place. In this manner, mistakes in the installation of the inline carbonator are prevented.

Thus, the present invention also covers a method to outfit conventional carbonation systems or impregnation systems with at least an additional carbonator system, which preferably includes at least one hollow body inline carbonator, which is either empty or filled with granulate and can also have connecting means for the gas and liquid supply of an additional inline carbonator.

Object of the invention is avoiding the drawbacks of the known carbonators or impregnators that are prone to problems and that do not impregnate the liquid with sufficiently fine beaded gas. This results for example in soft drinks such as Coca Cola® Light starting to foam very much when drawing the soft drink via a post-mix tap, respectively a post-mix faucet thereby requiring long intervals for drawing. Accordingly, such tap action poses a problem when drawing with a conventional carbonator system.

It has to be generally assumed that all beverages which are tapped in the post-mix area are prone to strong foaming. The foaming even increases when the cooling system located either downstream or upstream of a particular system which needs to fulfill high tapping demands, collapses such that the temperature of the tapped drinks increases. In that case, the foam formation increases further and the tapping action has to be interrupted until the temperature has lowered again. Some drinks are diluted with still water from a still water reservoir in order to dilute the carbonated liquid with still water since it would be impossible to properly draw the drink for the tap due to foaming.

A further generally known problem is encountered with older carbonator or impregnation systems which are worn from use and which therefore need to be calibrated several times a week. This is very work intensive and time consuming, even aside from the cost incurred.

The afore-stated problems are also seen routinely in non-refrigerated carbonators, shock carbonators, or recirculation carbonator systems. All manufacturers of these systems face the same problems with foaming and temperature fluctuations.

For the most part, the invention eliminates these problems completely with little expenditure and cost. This can be realized for example by installing one or more hollow body inline carbonators filled with granulate downstream of the already existing impregnator and allowing the already carbonated liquid to flow through the hollow body impregnating system for a post-impregnation or post-carbonation and only then to the tapping points for tapping.

This so-called independent post-impregnation without the need for additional gas or still water ensures that the liquid which is already enriched with gas can be post-impregnated. This post-carbonation has the advantage that when impregnating by means of a granulate filled hollow body, the carbonated liquid contains the gas in finely beaded form. This results in an impregnation over a very large surface in the hollow body such that due to the extremely fine beaded carbonation and the extreme adsorption in the liquid, foaming in post-mix beverages no longer occurs due to high sugar content or high sweetener content, while the old methods cannot ensure impregnation or carbonation to realize intensive adsorption in the liquid. Those allow only short term impregnations because the high sugar or sweetener content in the syrups or beverage supplements release the gas from the liquid causing the syrup or the drink supplements to foam. When mounting a downstream hollow body inline impregnation system preferably filled with granulate, that is, in the supply line or lines for the tapping point and after the already existing impregnation system, such problems cannot occur anymore. The additionally added hollow body inline impregnator can be operated with refrigerated or unrefrigerated liquids. Preferably, the hollow body or the hollow body impregnation system in recirculation impregnation systems is integrated into the circulation lines or line in the supply line for the taps. From retrofitted impregnation systems or tapping systems, beverages can be drawn even when the temperature fluctuates without loss of quality and without the formation of foam.

A further notable advantage is that while the old impregnation system no longer has capacity to impregnate independently and only supplies the hollow-body inline impregnation system with still water, operation of the system can nevertheless continue in that the hollow body impregnation system is then connected to one or more gas supplies, which is easily possible with the assembly of the hollow body inline impregnation system. Thus, the old system can remain in operation when it is provided with one or more hollow body inline impregnation systems. The afore-stated possibilities are advantageously the same and can be applied with new assemblies of impregnation systems and are preventative of failures with respect to conventional impregnation systems. A new generation of impregnating systems or tapping systems can be as advantageous as cost efficient in that the hollow body impregnations systems are supplied with for example, liquid and gases, preferably refrigerated liquids and if needed in order to ensure a constant flow pressure for the liquids, to use one or more liquid pressure elevator pumps in order to also ensure maintaining the prescribed drawing speeds in a post-mix area.

The cost advantage and the trouble-free installation assembled from hollow body impregnation systems for producing refreshing beverages is of great advantage for operators of such systems as well as to the customers and to the companies, which will built these systems.

The drawing in FIG. 1 shows a schematic illustration of a hollow body inline carbonator system with supply lines for gases or/and liquids having all necessary connection devices, for example brackets or attachment elements, exit lines for impregnated or non-impregnated liquids or still liquids. A supply line for taps or a faucet, another component for drawing liquids in order to attach one or more lines for impregnated or non-impregnated liquids to the tapping points or tapping point. The afore-stated component also serves as a retainer for the granulate preferably filled in the hollow body so that the granulate cannot be flushed from the hollow body. Prior to closure, separate security means can be tightly connected to the wall of the hollow body, preferably strainers or a strainer. In order to close the hollow body, preferably one or more clamp means can be used in connection with sealing means such as O-rings or an O-ring. The component which serves to supply the gas and liquid to the inline hollow body impregnation system, is preferably provided with one or more screw threads to close the impregnation system with the component, for example, such that the granulate cannot be flushed out. Separate means for retaining the granulate in the hollow body can also be provided. The afore-stated component can be clamped to the hollow body and then preferably screwed into the hollow body in order to realize supply of the liquids and the gases or for pre-impregnated liquids in the direction of the hollow body impregnation system preferably carrying the granulate.

This component can preferably be provided with control valves which at the same time can be configured as check valves to regulate any reflux. Control valves can also be integrated into the supply means for the component for the liquid and gas supply for the hollow body inline impregnating system. If needed, the supply of gas and liquids or the supply of pre-impregnated liquids can be realized via a component whereby the component is provided with one or more liquid or gas pressure gauges. The hollow body inline impregnator can be preferably operated with pre-refrigerated or non-refrigerated impregnated liquids.

One or more carbonators or impregnation systems (not shown here) can be either additionally fitted or retrofitted with one or more hollow body-inline-impregnation systems (1) (2) (7) (13) (not shown here).

The integration (not shown here) is carried out as follows: The either refrigerated or non-refrigerated already impregnated liquid is connected to the lines (24) (22) (10) or the lines (10) (21) (23) (20) (22) (24). This also goes for recirculation carbonators or impregnation systems (not shown here).

The line (3) or the lines (3) (5) (6) (25) are then attached to the component (4) and the line (3) or (3) (5) (6) (25) connected with one or more distributors (not shown here) alternatively, connected directly to the tapping faucets or tapping faucet (not shown here). After that step (not shown here), the liquid, which already has been pre-impregnated or liquid containing gas flows via the line (10 or (20) or via the lines (10) (21) (23) (24) (22) (20) and via those or the component (1 1) (1 2) (26) (15) (14) (16) (27) (17) (19) into the hollow body impregnation system which is preferably filled with granulate (not shown here), with post-impregnated or newly impregnated liquid exiting through line (3) or lines (3) (5) (6) (25) via the component (4) and the hollow inline impregnation carbonator (1) (7) (2) (13) which is preferably loaded with granulate ( not shown here).

A subsequent supply of gas for one or more hollow body inline impregnators can be carried out via line (10) (20) or lines (10) (21) (23) (20) (22) (24) in order to concentrate the already impregnated or non-impregnated liquids.

The bracket (9) is preferably used for attachment of the one or more hollow body inline impregnators (10) (21) (23) (20) (22) (24).

The hollow body inline impregnator systems (7) (2) (1) (13) can be constructed in a variety of forms, however preferred are the U-shaped form or the L-shaped form. (not shown here).

The hollow body inline carbonator (1) (2) (7) (13) can also be utilized to supply tapping systems for impregnated liquids in order to preferably produce refreshment beverages or to supply filling stations for industrial use (not shown here).

The hollow body inline carbonation system (1) (2) (7) (13) can also be operated with a pump for increasing pressure in liquids at connectors (10) (21) (23) (20) (22) (24) (not shown here).

1. A method for increasing the adsorption of gas into water which is gassed at least in a gassing chamber, characterized in that the gas/water mixture, after leaving the gassing chamber, is guided through at least one gassing device located downstream of the gassing chamber, in which the gas/water mixture is being thoroughly mixed.

2. The method according to claim 1, characterized in that a carbonator chamber (48) and an inline carbonator (26) are utilized for the gassing with CO₂.

3. The method according to claim 1, characterized in that the gas/water mixture is guided across granulate inside the inline carbonator.

4. The method according to claim 3, characterized in that the granulate is filled into a hollow body surrounding the inline carbonator in the form of flowable bulk material.

5. The method according to claim 1, characterized in that an additional amount of gas is introduced into the gas/water mixture upon leaving the gassing chamber (48) and before entry into the inline carbonator (26).

6. The method according to claim 2, characterized in that in the inline carbonator (26) a pressure is maintained suitable for drawing a finely beaded gas/water mixture from a tap.

7. The method according to claim 6, characterized in that the gas/water mixture undergoes cooling prior to entry into the inline carbonator (26).

8. The method according to claim 2 characterized in that the liquid impregnated in the inline carbonator (26) is tapped from certain tapping points (32).

9. The method according to claim 2 characterized in that the carbonator chamber (48) and the inline carbonator are utilized for industrial filling of refreshment beverages.

10. The method according to claim 9, characterized in that the inline carbonator (26) is integrated into a cooler.

11. The method according to claim 2, characterized in that the carbonator chamber (48) has at least one location for inputting liquid into the carbonator chamber (48).

12. The method according to claim 1, characterized in that there is at least one input opening at the inline carbonator (26) for inputting liquid into the inline carbonator.

13. The method according to claim 2, characterized in that inputting the liquid and the gas into the inline carbonator (26) is carried out in mutual dependence on the pressure of each the gas and the liquid.

14. The method according to claim 1, characterized in that a tapping system including a gassing chamber can be retrofitted with an inline carbonator (26).

15. The method according to claim 14, characterized in that carbonation in the inline carbonator takes place only upon tapping of arbonized liquids.

16. The method according to claim 4, characterized in that the hollow body of the inline carbonator (26) comprises three interconnected layers.

17. The method according to claim 16, characterized in that the innermost layer of the hollow body of the inline carbonator (26) is from plastic and covered by a middle layer from aluminum which is provided with an outer layer of plastic.

18. The method according to claim 2, characterized in that through integration of an inline carbonator (26), formation of foam is suppressed when tapping soft drinks.

19. The method according to claim 1, characterized in that prior to introducing carbonation in the carbonator chamber (48), the pressure of the liquid entering the carbonator chamber (48) is kept constant by means of a pressure elevator pump.

20. The method according to claim 19, characterized in that the carbonator chamber (48) and the recirculation carbonator (73) are combined into a post-mix system.

21. The method according to claim 19, characterized in that in one recirculation carbonator (73) two inline carbonators (26) are mounted parallel in a circular line.

22. The method according to claim 1, characterized in that a post-mix system for refreshment beverages is provided with an inline carbonator (26) in an output line (51) of a shock carbonator.

23. The method according to claim 21, characterized in that two inline carbonators (26) are mounted parallel to each other in an output line (51) of a shock carbonator.

24. The method according to claim 23, characterized in that in a shock carbonator (80) the gas/water mixture under pressure form the carbonator chamber (48) is flowing through the inline carbonator (26) received within the carbonator chamber (56) directly following the cooling system.

25. The method according to claim 24, characterized in that the gas/water mixture under pressure from the carbonator chamber (48) is passing through two parallel mounted inline carbonators (26) received inside the water basin (56).

26. The method according to claim 25, characterized in that each of the at least two inline carbonators (26) through which the gas/water mixture flows are provided with a separate line for the gas/water mixture under pressure from the carbonator chamber (48).

27. The method according to claim 20, characterized in that in a recirculation carbonator (73), the inline carbonator (26) downstream of the carbonator chamber (48) is integrated into the circular line within the water basin (56).

28. The method according to claim 27, characterized in that in a recirculation carbonator (73) the gas/water mixture under pressure from the carbonator chamber (48) is passing through two inline carbonators (26) mounted parallel to each other within the water basin (56).

29. A device for increasing adsorption of gas into water which is gassed at least in a carbonator chamber, characterized in that an inline carbonator is installed downstream of the carbonator chamber and at an exit opening for the gassed water at the carbonator chamber, wherein the water is thoroughly mixed within the inline carbonator.

30. The device according to claim 29, characterized in that the gassing chamber is constructed as a carbonator chamber (48) and the inline gassing device is constructed as an inline carbonator (26) for gassing the water with CO₂.

31. The device according to claim 29, characterized in that the inline carbonator (26) is filled with a granulate.

32. The device according claim 29, characterized in that the carbonator chamber (48) is disposed within a recirculation carbonator (73).

33. The device according to claim 29, characterized in that the carbonator chamber (48) is disposed within a shock carbonator (80).

34. The device according to claim 29, characterized in that the inline carbonator (26) is disposed outside a housing which houses the carbonator chamber (48) and a cooling system (48, 49).

35. The device according to claim 29, characterized in that the inline carbonators (26) interior of a housing which houses the carbonator chamber (48) and the inline carbonator (26).

36. The device according to claim 29, characterized in that between the carbonator chamber (48) and the inline carbonator (26) a cooling system (49) is provided fro flow-through of the gas/water mixture which is under pressure from the carbonator chamber (48).

37. The device according to claim 29, characterized in that in a recirculation carbonator (3) the inline carbonator (26) is disposed in a branch of a circulation line, which is under elevated pressure generated by a displacement pump (53) as compared to the circulation line.

38. The device according to claim 33, characterized in that in a shock carbonator (80) the inline carbonator (26) is provided with an exit line (29) of the carbonator chamber (48) connected to tapping points.

39. The device according to claim 38, characterized in that the inline carbonator (26) comprises a granulate filled hollow body whose opposite openings are each closed by means of a flange (63) and provided with a bore (66) which each extends in the direction of an inner space that is surrounded by a hollow body and wherein at a side facing away from the inner space is surrounded with cylindrical shaped slide-on surfaces (64, 65), each of the flange (66) facing inner slide-on surface (63) has a larger diameter as compared to the outer slide-on surface facing away from the flange (63).

40. A method for carrying out an additional post carbonation or impregnation by means of one or more hollow body inline impregnator or carbonator systems filled with granulate (1) (2) (7) (13) and to provide tapping valves or (faucets) for the so post-impregnated liquids which may be cooled, and for producing and tapping refreshment beverages via at least one hollow body inline impregnation system filled preferably with granulate (10 92) (7) (13) and via the hollow body Inline carbonators (1) (2) (7) (13) supply impregnated liquids to the tap or tapping faucets.

41. The method according to claim 40 for a hollow body inline impregnation system (1) (2) (7) (13) characterized in that already impregnated liquids can be post-impregnated or post-carbonated through the hollow body inline impregnation system (1) (2) (7) (13) without supplying additional gas or liquid.

42. The method according to claim 40 for a hollow body inline impregnation system (1) (2) (7) (13) characterized in that several hollow body inline impregnation systems can be in operation simultaneously.

43. The method according to claim 42 for a hollow body inline impregnation systems (1) (2) (7) (13) characterized by using also refrigerated liquids.

44. The method according to claim 43 for a hollow body inline impregnation system (1) (2) (7) (13) characterized in that one or more hollow body inline impregnator systems supply refrigerated or non-refrigerated impregnated liquids to at least one tap for producing post-carbonated or impregnated liquids.

45. The method according to claim 40 for a hollow body inline impregnation system (1) (2) (7) (13) characterized in that impregnation is carried out independently by means of the hollow body inline impregnation system (1) (2) (7) (13) under addition of refrigerated and non-refrigerated gases and liquids.

46. The method according to claim 45 for a hollow body inline impregnation system (1) (2) (7) (13) characterized in that the system can be of different construction and assembly.

47. The method according to claim 40 for a hollow body inline impregnation system (1) (2) (7) (13) characterized in that one or more hollow body inline impregnation systems (1) (2) (7) (13) can be used for industrial filling of refreshment beverages.

48. The method according to claim 47 for a hollow body inline impregnation system (1) (2) (7) (13) characterized in that the impregnated or carbonated liquids can be drawn from the tap with fine beads.

49. The method according to claim 40 for a hollow body inline impregnation system (1) (2) (7) (13) characterized in that hollow body inline impregnation system (1) (2) (7) (13) can be utilized integrated directly into a refrigeration machine of any type.

50. The method according to claim 49 for a hollow body inline impregnation system (1) (2) (7) (13) characterized in that at least one liquid supply is provided.

51. The method according to claim 50 for a hollow body inline impregnation system (1) (2) (7) (13) characterized in that at least one liquid and gas supply is provided for the hollow body inline impregnation system (1) (2) (7) (13).

52. The method according to claim 40 for a hollow body inline impregnation system (1) (2) (7) (13) characterized in that the existing impregnation or carbonator system can be retrofitted or added on to with at least one hollow body inline impregnation system (1) (2) (7) (13).

53. The method according to claim 40 for a hollow body inline impregnation system (1) (2) (7) (13) characterized in that carbonating or impregnating takes place preferably only when tapping from the tap or taps and thus carbonation or impregnation takes pace in a continuous operation.

54. The method according to claim 40 for a hollow body inline impregnation system (1) (2) (7) (13) characterized in that at least one liquid supply line connector and at least one liquid exit line for the refrigerated or non-refrigerated liquids is provided, wherein the hollow body inline impregnator preferably is made with three-layers, with an inner layer of plastic,preferably polyethylene, an intermediate layer from aluminum and the third layer preferably from plastic or other suitable materials.

55. The method according to claim 54 for a hollow body inline impregnation system (1) (2) (7) (13) characterized in that the formation of foam is suppressed when tapping the soft drinks from the tap or taps.

56. The method according to claim 55 for a hollow body inline impregnation system (1) (2) (7) (13) characterized in that prior to impregnation or carbonation, the liquid pressure is preferably kept constant by using at least one pressure elevating pump.
